(19) United States
(12) Patent Application Publication
(10) Pub. No.: US 2016/0212395 A1
(43) Pub. Date: Jul. 21, 2016

(54) METHOD OF DETERMINING AN OPTIMAL POINT IN THREE-DIMENSIONAL SPACE

(71) Applicants: NCKU Research and Development Foundation, Tainan City (TW); Himax Technologies Limited, Tainan City (TW)

(72) Inventors: MING-DER SHIEH, Tainan City (TW); Ching-Heng Su, Tainan City (TW); TZUNG-REN WANG, Tainan City (TW)

(21) Appl. No.: 14/601,691

(22) Filed: Jan. 21, 2015

(51) Int. Cl. H04N 9/31; G06K 9/52

(52) U.S. Cl. CPC H04N 9/3185; G06K 9/52

(57) ABSTRACT

A method of determining an optimal point in three-dimensional space includes obtaining a first vector and a second vector originating from a first and second imaging device respectively, and obtaining a third vector with minimum length perpendicular to both the first vector and the second vector. A candidate point vector along the third vector is reprojected onto a first and second image at a first and second reprojected point respectively, according to which the optimal point is determined.

### BACKGROUND OF THE INVENTION

1. Field of the Invention

The present invention generally relates to triangulation, and more particularly to correcting an image before projection by using triangulation.

2. Description of Related Art

Triangulation or reconstruction is used in computer vision to determine a point in 3D space given its projections onto two or more images. In ideal situation, a pair of projection lines generated by image points should intersect at a point in 3D space, and the coordinates of that point can be computed by algebraic technique. In practice, however, the pair of projection lines does not intersect in 3D space due to noise, such as lens distortion or other distortions.

There are methods in the literature for optimally determining a point in 3D space when noise is involved. For example, polynomial, linear least square (linear-LS), iterative-LS and mid-point are commonly used, among which the polynomial method has highest accuracy and computation complexity, and the mid-point method has the lowest accuracy and computation complexity.

Due to high computation complexity, most methods such as linear-LS (e.g., singular value decomposition or SVD), iterative-LS and polynomial cannot be put into practice at low cost. A need has thus arisen to propose an improved scheme for improving, for example, the mid-point method to greatly obtain higher accuracy while substantially maintaining its low computation complexity.

### SUMMARY OF THE INVENTION

In view of the foregoing, it is an object of the embodiment of the present invention to provide a method of determining a projection point, based on which an image to be projected may be corrected beforehand and perceived without distortion. The method of the embodiment has higher accuracy than conventional mid-point method.

According to one embodiment, a first vector originating from a first imaging device through a first feature point on a first image provided by the first imaging device is obtained, and a second vector originating from a second imaging device through a second feature point on a second image provided by the second imaging device is obtained. A third vector with minimum length is obtained, the third vector being perpendicular to both the first vector and the second vector. A candidate point vector along the third vector is obtained. The candidate point vector is reprojected onto the first image at a first reprojected point, and the candidate point vector is reprojected onto the second image at a second reprojected point. The optimal point is determined by minimizing a sum of a first squared distance between the first reprojected point and the first feature point, and a second square distance between the second reprojected point and the second feature point. Alternatively, a first epipolar line that connects the first feature point and a first epipolar point is obtained, and a second epipolar line that connects the second feature point and a second epipolar point is obtained. The optimal point is determined by minimizing a sum of a first squared distance between the first epipolar line and the first feature point, and a second square distance between the second epipolar line and the second feature point.

### BRIEF DESCRIPTION OF THE DRAWINGS

FIG. 1 shows a schematic diagram illustrating a set-up for determining a point in three-dimensional (3D) space according to one embodiment of the present invention;

FIG. 2A shows an image to be projected and a distorted image perceived by a viewer;

FIG. 2B shows a corrected image to be projected and an image perceived by a viewer;

FIG. 3A shows a flow diagram illustrating a method of determining an optimal projection point according to a first specific embodiment of the present invention;

FIG. 3B shows a set-up in vector form for performing the method of FIG. 3A;

FIG. 4A shows a flow diagram illustrating a method of determining an optimal projection point according to a second specific embodiment of the present invention; and FIG. 4B shows a set-up for performing the method of FIG. 4A.

### DETAILED DESCRIPTION OF THE INVENTION

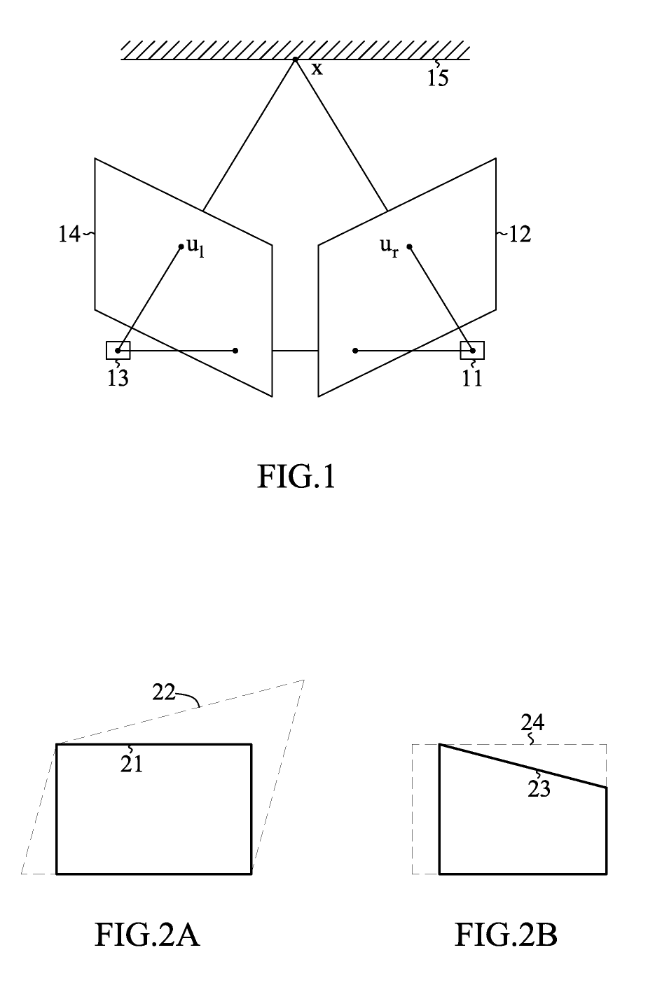

FIG. 1 shows a schematic diagram illustrating a set-up for determining a point X in three-dimensional (3D) space according to one embodiment of the present invention. In the embodiment, a projector 11 provides a first image 12 with a first feature point uᵣ, and a camera 13 captures a second image 14 with a second feature point u₁. Specifically, the first feature point uᵣ is projected on a projection surface 15 at a projection point X associated with the first feature point uᵣ and the second feature point uᵣ.

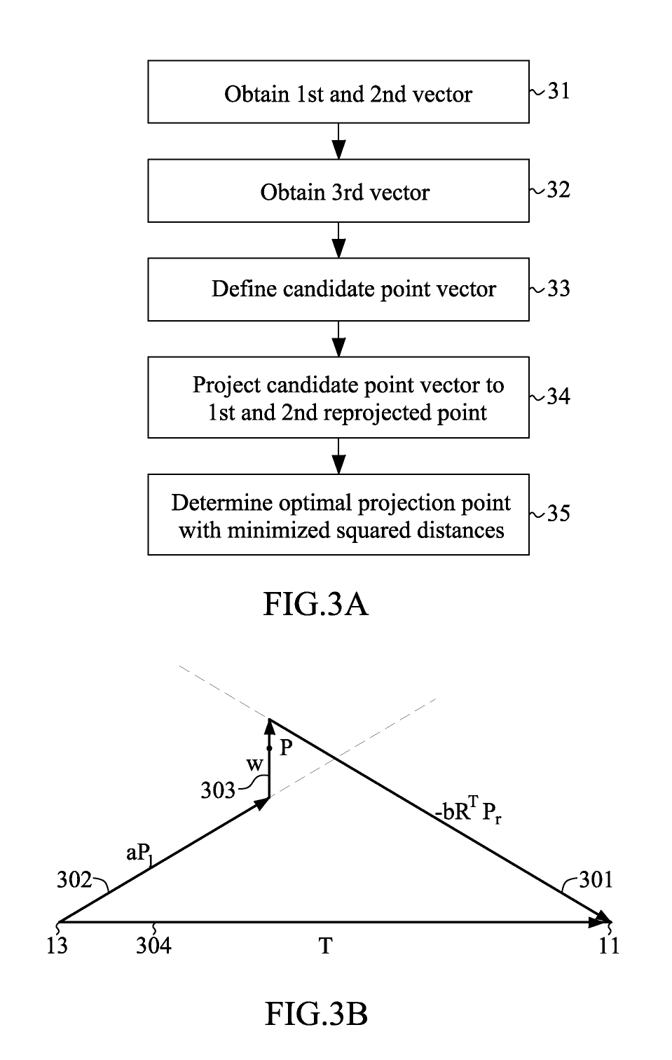

In practice, an image (e.g., a white rectangle 21 as shown in FIG. 2A) projected on the projection surface 15 by the projector 11 may probably result in a distorted quadrangle 22 (as exemplified in FIG. 2A) as perceived by a viewer. It is thus one of objects of the embodiment to utilize the first image 12 and the second image 14 to determine projection points associated with feature points (e.g., four corners), according to which the first image 12 may be corrected before projection. As exemplified in FIG. 2B, correction is performed before projection to generate a quadrangle 23, such that the viewer may perceive a rectangle 24. Accordingly, if the projector 11 is corrected in this manner subsequent to turn-on of the projector 11 (or activation by a user), the viewer may perceive an image without distortion. The projector 11 and the camera 13 therefore form a projector-camera calibration scheme, details of which may, for example, be referred to “Projector-Camera Calibration/3D Scanning Software” (http://mesh.brown.edu/calibration/), contents of which are incorporated herein by reference.

Methods of determining the projection point X will be detailed in the following. It is appreciated that the methods described in the specification may be adapted to applications other than that mentioned above. Generally speaking, the projector 11 in FIG. 1 may be a first imaging device that provides the first image 12, and the camera 13 in FIG. 1 may be a second imaging device that provides the second image 14. It is appreciated that the embodiments described below are partially based on basis of conventional methods, for example, disclosed in “Multiple View Geometry in Computer Vision, Second Edition” by Richard Hartley et al., and “Triangulation,” COMPUTER VISION AND IMAGE UNDERSTANDING Vol. 68, No. 2, November, pp. 146-157, 1997 by Richard Hartley et al., contents of which are incorporated herein by reference.

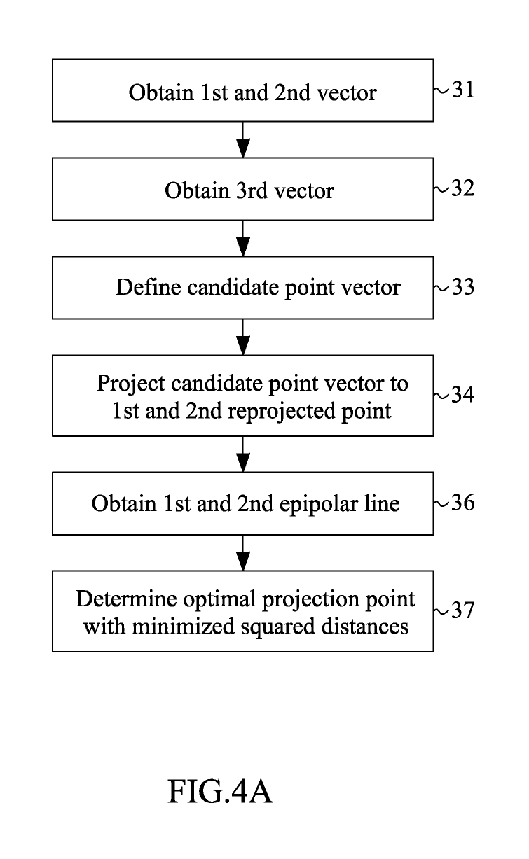

B sent invention. FIG. 3B shows a set-up in vector form for performing the method of FIG. 3A.

In step 31, a first vector 301 is obtained that originates from the projector 11 through a first feature point uᵣ (FIG. 1), and a second vector 302 is obtained that originates from the camera 13 through a second feature point u₁ (FIG. 1). As shown in FIG. 3B, due to noise (e.g., lens distortion), the first vector 301 and the second vector 302 will generally not intersect.

In step 32, a third vector 303 with minimum length is obtained that is perpendicular to both the first vector 301 and the second vector 302. The first vector 301, the second vector 302, the third vector 303 and a translation vector (between the projector 11 and the camera 13) 304 may form a closed vector path, which may be expressed as

aP₁+w−bR^{T}Pᵣ=T (1)

where Pᵣ has the same direction as the first vector 301, Pₗ has the same direction as the second vector 302, w is the third vector 303, T is the translation vector 304, R is a rotation matrix, and a and b are constants.

In step 33, a candidate point vector P is then defined along the third vector 303 (or w) as

P=aP₁+cw (2)

where c is a variable with a value in a range of 0 and 1.

In step 34, the candidate point vector P is reprojected onto the first image 12 at a first reprojected point ûᵣ:

ûᵣ=K_{C2}[R|t]{aPₗ+cw} (3)

where K_{C2} is 3D-to-2D transformation matrix, and t is translation vector between camera and projector 3D coordinate system. It is noted that the first reprojected point ûᵣ is a function of c, that is, ûᵣ(c).

Similarly, the candidate point vector P is reprojected onto the second image 14 at a second reprojected point ûₗ:

ûₗ=K_{C1}{aP₁+cw} (4)

where K_{C1} is 3D-to-2D transformation matrix. It is noted that the second reprojected point ûₗ is a function of c, that is, û₁(c).

Finally, in step 35, a value of the variable c is found that minimizes a sum of a first squared distance between the first reprojected point ûᵣ and the first feature point uᵣ, and a second square distance between the second reprojected point ûₗ and the second feature point uₗ, that is

arg min_{c=0-1}{d(ûᵣ(c),uᵣ)²+d(ûₗ(c), uₗ)²} (5)

In one exemplary embodiment, (5) may approximately be quadratic formula, e.g., f(c)=a₁c²+a₂c+a₃, which has a single local minimum value, which may be obtained, for example, by substituting at least three points into the quadratic formula. The value of c found in (5) may thus determine an optimal projection point P.

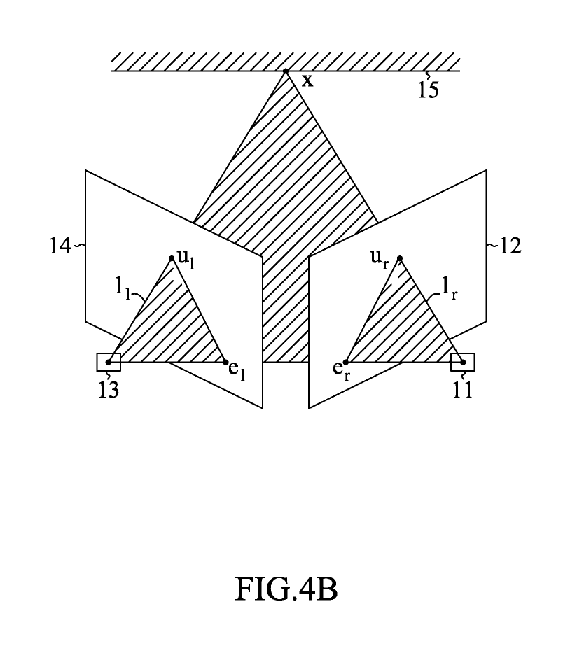

FIG. 4A shows a flow diagram illustrating a method of determining an optimal projection point P (or, generally, an optimal point P in 3D space) according to a second specific embodiment of the present invention. FIG. 4B shows a set-up for performing the method of FIG. 4A. FIG. 3B may be continuously used in the present embodiment.

Steps 31 to 34 of FIG. 4A are the same as in the preceding embodiment (FIG. 3A) for obtaining the first reprojected point ûᵣ (FIG. 1) and the second reprojected point ûₗ (FIG. 1).

Subsequently, in step 36, a first epipolar line lᵣ, which connects the first feature point Uᵣ and a first epipolar point eᵣ (that is an intersection point of the translation vector T and the first image 12). Similarly, a second epipolar line lₗ, which connects the second feature point uₗ and a second epipolar point eₗ (that is an intersection point of the translation vector T and the second image 14). The first epipolar line lᵣ may be obtained according to the second reprojected point ûₗ, and the second epipolar line lₗ may be obtained according to the first reprojected point ûᵣ:

lᵣ(c)=Fûₗ(c)

lₗ(c)=Fûᵣ(c) (6)
where F=K_{C1}R[t]_{X}K_{C2}⁻¹
   where F is a fundamental matrix representing transformation between pixel image coordinate seen by the projector 11 and the camera 13. Details about fundamental matrix F and epipolar geometry may be referred to aforementioned “Multiple View Geometry in Computer Vision, Second Edition.”

Finally, in step 37, a value of the variable c is found that minimizes a sum of a first squared distance between the first epipolar line lᵣ and the first feature point uᵣ, and a second square distance between the second epipolar line lₗ and the second feature point uₗ, that is

arg min_{c=0-1}{d(lᵣ(c),uᵣ)²+d(l₁(c),u₁)²} (7)

In one exemplary embodiment, (7) may approximately be quadratic formula, e.g., f(c)=a₁c²+a₂c+a₃, which has a single local minimum value, which may be obtained, for example, by substituting at least three points into the quadratic formula. The value of c found in (7) may thus determine an optimal projection point P.

Although specific embodiments have been illustrated and described, it will be appreciated by those skilled in the art that various modifications may be made without departing from the scope of the present invention, which is intended to be limited solely by the appended claims.

What is claimed is:

1. A method of determining an optimal point in three-dimensional space, comprising:
obtaining a first vector originating from a first imaging device through a first feature point on a first image provided by the first imaging device;
obtaining a second vector originating from a second imaging device through a second feature point on a second image provided by the second imaging device;
obtaining a third vector with minimum length, the third vector being perpendicular to both the first vector and the second vector;
defining a candidate point vector along the third vector;
reprojecting the candidate point vector onto the first image at a first reprojected point; and
reprojecting the candidate point vector onto the second image at a second reprojected point;
wherein the optimal point is determined by minimizing a sum of a first squared distance between the first reprojected point and the first feature point, and a second square distance between the second reprojected point and the second feature point.

2. The method of claim 1, wherein the first imaging device comprises a projector and the second imaging device comprises a camera.

3. The method of claim 2, wherein the first feature point is projected on a projection surface at a projection point associated with the first feature point and the second feature point.

4. The method of claim 3, further comprising:
determining a plurality of projection points associated with a plurality of feature points of the first image;
correcting the plurality of features points of the first image according to the plurality of projection points; and
projecting the first image with the corrected plurality of feature points onto the projection surface.

5. The method of claim 4, wherein the plurality of feature points comprises four corners of a rectangle on the first image.

6. The method of claim 4, wherein the steps recited in claim 4 are performed immediately subsequent to turn-on of the projector.

7. A method of determining an optimal point in three-dimensional space, comprising:
obtaining a first vector originating from a first imaging device through a first feature point on a first image provided by the first imaging device;
obtaining a second vector originating from a second imaging device through a second feature point on a second image provided by the second imaging device;
obtaining a third vector with minimum length, the third vector being perpendicular to both the first vector and the second vector;
defining a candidate point vector along the third vector;
reprojecting the candidate point vector onto the first image at a first reprojected point;
reprojecting the candidate point vector onto the second image at a second reprojected point;
obtaining a first epipolar line that connects the first feature point and a first epipolar point, which is an intersection point of the first image and a translation vector between the first imaging device and the second imaging device;
obtaining a second epipolar line that connects the second feature point and a second epipolar point, which is an intersection point of the second image and the translation vector;
wherein the optimal point is determined by minimizing a sum of a first squared distance between the first epipolar line and the first feature point, and a second square distance between the second epipolar line and the second feature point.

8. The method of claim 7, wherein the first epipolar line is obtained according to the second reprojected point, and the second epipolar line is obtained according to the first reprojected point.

9. The method of claim 7, wherein the first imaging device comprises a projector and the second imaging device comprises a camera.

10. The method of claim 9, wherein the first feature point is projected on a projection surface at a projection point associated with the first feature point and the second feature point.

11. The method of claim 10, further comprising:
determining a plurality of projection points associated with a plurality of feature points of the first image;
correcting the plurality of features points of the first image according to the plurality of projection points; and
projecting the first image with the corrected plurality of feature points onto the projection surface.

12. The method of claim 11, wherein the plurality of feature points comprises four corners of a rectangle on the first image.

13. The method of claim 11, wherein the steps recited in claim 11 are performed immediately subsequent to turn-on of the projector.
